(19) United States
(12) Patent Application Publication
(10) Pub. No.: US 2003/0211800 A1
(43) Pub. Date: Nov. 13, 2003

(54) Composite nonwoven fabric and process for its manufacture

(76) Inventors: Graham Kirk Duncan, Berwickshire (GB); Alan William Meierhoefer, Frederick, MD (US); Raymond Anthony Volpe, Wethersfield, CT (US)

Correspondence Address: ALIX YALE & RISTAS LLP, 750 MAIN STREET, SUITE 1400, HARTFORD, CT, 06103, US

(21) Appl. No.: 10/169,682

(22) PCT Filed: Jan. 5, 2001
(86) PCT No.: PCT/US01/00320

(51) Int. Cl. D04H 1/00; D04H 3/00; B32B 5/26; B32B 5/06

(52) U.S. Cl. 442/381; 442/382; 442/383; 442/384; 442/385; 442/387; 442/401; 442/412; 442/413; 442/409

(57) ABSTRACT

A composite nonwoven fabric manufactured by joining a fibrous web that comprises wood fibers, or a mixture of wood fibers and synthetic fibers, to a spunlaid or other nonwoven baseweb by means of a hydroentanglement process. The spunlaid nonwoven web, which may be made of a polyester such as a poly (ethylene terephthalate) or of a polyolefin such as polypropylene, is a less-than-fully bonded web, which may be produced by a method in which the thermal calendering is effected at lower than normal temperatures, in particular temperature lower than the melting point or softening point of the polymeric material from which the spunlaid nonwoven web is made. The strength of the composite fabric may be significantly greater than that of the spunlaid nonwoven web itself, in certain embodiments the base web contributes no more than about 45% of the strength of the composite fabric.

### FIELD OF THE INVENTION

This present invention relates generally to composite fabrics and to a process for the manufacture thereof. The invention relates especially but not exclusively to composite fabrics in which a fibrous web that comprises wood-pulp fibers is joined to a spunlaid web, and to processes wherein the joining of the webs is effected by hydroentanglement.

### BACKGROUND TO THE INVENTION

It has already been disclosed in U.S. Pat. No. 5,151,320 (Homonoff et al.) and U.S. Pat. No. 5,573,841 (Adam et al) that a composite nonwoven material may be made by combining a spunbonded nonwoven and wood pulp by means of high-pressure water jets. However, it is inferred from the disclosure in these United States patents that a fully bonded spunbonded nonwoven is used and the strength properties of the resultant composite are similar to those of the spunbonded starting material.

### SUMMARY OF THE INVENTION

The present invention in one of its aspects provides a composite nonwoven fabric that comprises a first web, said first web being a nonwoven web that comprises filaments and/or fibers of man-made polymer, to which first web there is joined a second web by fiber entanglement, the second web being a fibrous web that comprises cellulose pulp fibers, characterized in that the said first web is a bonded nonwoven web that is less than fully bonded.

The present invention in another of its aspects provides a composite nonwoven fabric that comprises a first web, said first web being a nonwoven web that comprises filaments and/or fibers of man-made polymer, to which first web there is joined a second web by fiber entanglement, the second web being a fibrous web that comprises cellulose pulp fibers, characterized in that the strength of the said first web is not more than about 45% of the strength of the said composite nonwoven fabric.

The present invention is yet another of its aspects also provides a process for the manufacture of a composite nonwoven fabric in which a first web, being a nonwoven web that comprises filaments and/or fibers of man-made polymer, is joined to a second web by hydroentanglement, the second web being a fibrous web that comprises cellulose pulp fibers, characterized in that the said first web is a nonwoven web that is less than fully bonded.

The present invention in a further aspect thereof provides a process for the manufacture of a composite nonwoven fabric in which a first web, being a nonwoven web that comprises filaments and/or fibers of man-made polymer, is joined to a second web by hydroentanglement, the second web being a fibrous web that comprises cellulose pulp fibers, characterized in that the strength of the said first web is not more than about 45% of the strength of the said composite nonwoven fabric.

For avoidance of doubt, it is declared that the expression “fiber entanglement” and the like herein include fiber-filament entanglement as well as fiber-fiber entanglement.

### BRIEF DESCRIPTION OF THE DRAWING

FIG. 1 is a graph illustrating addition of varying amounts of pulp to a minimally bonded base web and the total tensile strength of the resulting composite nonwoven fabric.

### DESCRIPTION OF EXEMPLARY EMBODIMENTS

The said first web may be regarded as a base web. The base web material preferably comprises synthetic or other man-made filaments or fibers, in particular substantially continuous filaments. The base web material will generally comprise filaments or fibers made of a thermoplastic material, for example filaments or fibers of a polyamide, polyurethane, polyester or polyolefin, or a copolymer, e.g. block copolymer, containing olefin monomer units. The base web may also comprise, or consist of, bi-component or bi-constituent or mixed filaments or fibers. Suitable thermoplastic filamentary materials are disclosed in U.S. Pat. No. 5,151,320 and U.S. Pat. No. 5,573,841, the teaching in each of these United States patents being incorporated herein by reference. In certain preferred embodiments, the base web comprises polyester filaments, especially polyethylene terephthalate (PET) filaments, or polyolefin filaments, for example polyethylene or polypropylene filaments. Man-made cellulosic fibers, such as viscose rayon or lyocell fibers, may also come into consideration.

Of course, the base web material may comprise a mixture of filaments or fibers of different materials, e.g., different thermoplastic materials. Furthermore, although in certain preferred embodiments the base web material will consist of, or consist essentially of, man-made, especially synthetic, and more especially thermoplastic, filaments and/or fibers, the presence of other, non-interfering components is not precluded. The filaments or fibers will usually have a linear density of from 0.1 to 6 denier (0.0111 to 0.667 tex), e.g., from 0.3 to 4.5 denier (0.033 to 0.5 tex) and typically from 0.5 to 3.5 denier (0.056 to 0.389 tex).

The web should be minimally bonded sufficient for it to maintain its integrity during handling in the hydroentanglement process. Preferably, the bonding is effected by thermal bonding, although other bonding methods, such as hydroentanglement, needle bonding, chemical bonding or adhesive bonding, may come into consideration, instead of or in addition to the thermal bonding. In certain preferred embodiments, the base web is a spun-laid web.

Nonetheless, the base material in any embodiment should be minimally bonded and should not be fully bonded. Such base materials include those, which are unbonded, lightly bonded, incompletely bonded or less than fully bonded. In general, such a material may be obtained by the normal methods for the production of bonded nonwoven materials with the modification that at least one of the usual bonding steps, e.g., the final bonding step, is omitted or carried out in a manner that is less intensive than normal, for example by using lower bonding temperatures, shorter bonding times, lower bonding pressures, lower entanglement energy inputs, lower needle density, lesser amounts of adhesive or other chemicals, or the like, as appropriate to the particular bonding method.

As one example spunlaid nonwovens or “spunbonded” materials are produced by bonding a spunlaid web by one or more techniques to provide fabric integrity. The spin laying of webs is disclosed, for example, in U.S. Pat. No. 4,340,563 and U.S. Pat. No. 3,692,618, the teaching is both of which is incorporated herein by reference. In the production of spun-laid nonwovens or spunbonded materials, the bonding or consolidation operation is normally carried out by means of a thermal calendering process involving the application of heat and pressure to the unbonded web. Full or complete bonding of the web material is indicated by the characteristic that thermal calendering of the unbonded web material at increased temperatures and/or pressures does not improve the strength properties of the resulting web material. As an example a spunlaid web comprising polyethylene terephthalate filaments may be thermally calendered at a temperature below the melting point of the polymer (about 265° C.) and at a “normal” pressure to produce a fully bonded nonwoven web. Naturally more than one combination of temperature and pressure will result in a fully bonded web material.

A less than-fully bonded spunlaid nonwoven material may be obtained by carrying out the thermal calendering process at a temperature that is lower than the melting point of the material from which the nonwoven has been made, for example lower than the softening point of that material and/or at a pressure below that normally used for that material. Thus, for example, the above spunlaid web comprising polyethylene terephthalate filaments may be thermally calendered at a temperature of from about 80° C. to 180° C., or more typically from about 140° C. to 160° C. and at a pressure equal to, or more preferably less than, the above normal pressure to provide a minimally bonded nonwoven web material. It is believed that the thermal calendering temperature should exceed the glass transition temperature of the polymer used, for example 80° C. in the case of polyethylene terephthalate. As would be expected the selection of a particular combination of material and thermal calendering temperature and pressure will result in a nonwoven web ranging from unbonded to fully bonded. The invention is most advantageous with base web materials that have been minimally bonded to a point sufficient only to provide for base web integrity until subsequent entanglement with the below-described second web.

The base web material, prior to the entanglement process, may optionally be subjected to cross-stretching by at least 5 percent of its original extent, as described in U.S. Pat. No. 5,151,320.

Prior to the entanglement process, the said second web, being a web comprising cellulose pulp fibers, is applied to the base web material. The web containing cellulose pulp fibers may be applied as a pre-formed web or tissue or may be formed on the base web material, for example by means of a wet-laying or air-laying process. The use of a pre-formed web (e.g. one formed by a wet-laying process) containing cellulose pulp fibers is currently preferred for manufacturing reasons. Ways in which a web comprising cellulose pulp fibers may be applied to a base web material are disclosed in the above-mentioned U.S. Pat. No. 5,151,320 and U.S. Pat. No. 5,573,841.

The cellulose pulp fibers may be derived from a wide range of naturally occurring sources of cellulose fibers, and are preferably wood pulp fibers (including hardwood pulp, soft wood pulp and mixtures thereof), although non-wood vegetable pulp fibers such as those derived from cotton, flax sisal, hemp, jute, esparto grass, bagasse, straw and abaca fibers may also come into consideration. Mixtures of various cellulose pulp fibers may also be used.

The cellulose pulp fibers, which may be used, include conventional short papermaking fibers, particularly having a fiber length of 25mm or less. The average fiber length is typically greater than 0.7mm and is most preferably from about 1.5 to 5mm. Conventional papermaking fibers include the conventional papermaking wood pulp fibers produced by the well-known Kraft process.

Preferably said second web is formed entirely, or substantially entirely, of cellulose pulp fibers, and more preferably wood pulp. The second web may also comprise synthetic or other man-made fibers, for example in an amount of up to 50 percent by weight of the total fiber content of the cellulose fiber-containing web based on economic considerations. Synthetic or man-made fibers can be added in greater amounts to achieve other desired properties. Such man-made fibers include, for example, fibers made of rayon, polyester, polyolefin (e.g., polyethylene or polypropylene), polyamide (e.g., a nylon) or the like. Suitable man-made fibers include those having a fiber length of from about 3 to 25 mm and a denier per filament of 1.0 to 3.0 (0.111 to 0.333 tex).

The basis weights (grammages) of the first and second webs may be selected according to the fiber and/or filament constitution and the intended end use. The first web, e.g., a spunlaid nonwoven web, will have a basis weight of, in general, from 5 to 100, preferably from 15 to 90 and typically from 20 to 70, grams per square meter (gsm). The second web, for example, a web formed of wood pulp fibers, will have a basis weight of, in general, from 5 to 100, preferably from 10 to 80 and typically from 20 to 60, gsm.

After assembly of the multi-layer structure comprising the base web material and the cellulose-fiber-containing web, the structure is subjected to a hydroentanglement operation, preferably a low to medium pressure hydroentanglement operation. Hydroentanglement operations are described in U.S. Pat. No. 4,883,709 (Nozaki) and in U.S. Pat. No. 5,009,747 (Viazmensky et al.), the disclosures of both of which are incorporated herein by reference. The hydroentanglement operation is preferably carried out by passing the multi-layer structure under a series of fluid streams or jets that directly impinge upon the top surface of the cellulose-fiber-containing layer with sufficient force to cause a proportion of the fibers therein, especially the short papermaking fibers, to be propelled into and entangled with the base web material. Preferably, a series or bank of jets is employed with the orifices and spacing between the orifices being substantially as disclosed in the aforesaid Nozaki patent or the Viazmensky et al. patent. The said fluid streams or jets are preferably streams or jets of an aqueous liquid.

As disclosed in the Viazmensky et al. patent, the total energy input provided by the fluid jets or streams may be calculated by the formula.

E=0.125YPG/bS

Wherein Y=the number of orifices per linear inch of manifold width, P=the pressure in psig (pounds per square inch gauge) of liquid in the manifold, G=the volumetric flow in cubic feet per minute per orifice, S=the speed of the web material under the fluid jets or streams in feet per minute and b=the basis weight of the fabric produced in ounces per square yard. The total amount of energy, E, expended in treating the web is the sum of the individual energy values for each pass under each manifold, if there is more than one manifold and/or if there is more than one pass. In general, the total energy input is from 0.07 to 0.4 horsepower-hours per pound (HPhr/lb) (0.41 to 2.37 MJ/kg). Preferably, however, the total energy input is from 0.1 to 0.3 HPhr/lb (0.59 to 1.78 MJ/kg), more preferably from 0.12 to 0.28 HPhr/lb (0.71 to 1.66 MJ/kg).

The minimally bonded nonwoven base web material having a low bond intensity that is employed in accordance with the present invention would have been expected to provide a comparatively low-strength base for combining with the fibrous sheet or web that contains cellulose fibers.

However, when the cellulose fibers are entangled into the incompletely bonded nonwoven material, it has surprisingly been found that the strength of the composite is significantly greater than that of the starting nonwoven base web material. Moreover, it has been found that the strength of the composite increases with higher pressures and/or higher energies used in the hydroentanglement process. Thus, if a less-than-fully bonded spun-laid nonwoven material without the application of wood pulp and a comparable, less-than-fully bonded spun-laid nonwoven material to which wood pulp has been applied are subjected to the same entanglement operation profile, the final strength of the nonwoven without the wood pulp is much lower than that of the nonwoven/wood pulp composite.

The beneficial effects of the wood pulp on the strength of the composite is unexpected because, first, there is no obvious mechanism whereby the cellulose may bond with the polymers used in the base web material (in particular PET or polypropylene) and, second, it is conceivable that the wood pulp would have acted to absorb energy from the entanglement jets and hence reduce their effect on strength generation. With the use of more highly bonded base web materials, our studies have shown that, although the starting strength of the spunbonded material may be higher, it changes much less during the entanglement process.

Interestingly, for lightly bonded base webs, not only is the strength of the composite after hydro-entanglement significantly increased over that of the same base web entangled on its own, but, if the wood pulp is subsequently removed from the final composite (for example by dissolving it with a suitable acid), the thus “regenerated” base web has a strength similar to that of the untreated, starting base web. Further, when a more fully bonded base web is used, similar removal of the wood pulp from the final composite again results in a “regenerated” base web that has strength properties very similar to those of the starting base web.

It has been found in general, that for entangled composites of this invention the strength of the untreated base web should contribute no more than approximately 45%, preferably no more than about 40%, and more preferably no more than about 35%, of the final composite strength, in particular of the total tensile strength of the final composite. The strength may be measured, for example, as the tensile strength in the machine direction (MD) or cross direction (CD) or as the total tensile strength (sum of the MD+CD tensile strengths).

The composite nonwoven fabrics manufactured according to the present invention may find use in a variety of applications, for example, as molding substrates (e.g., in the automotive industry), as geotextiles, as wiping materials, both wet and dry, and in the medical field as disposable garments such as surgical gowns and drapes. Depending upon the intended end-use, the composite fabrics of the present invention may include, in addition to the above-discussed fibrous components, various other additives such as surfactants, fire retardants, pigments, liquid-repellants, super-absorbents, molecular sieves, and various other particulates such as starches, activated charcoal or clay.

The use of the present invention can give rise to products having excellent aesthetic qualities. Entanglement of pulp fibers and the like into conventional fully thermally bonded spunlaid nonwovens normally results in a non-uniform appearance. For example, the thermal bondpoints become exposed and give the impression of defects or pinholes or lack of integrity. However, by using a minimally bonded or other less-than-fully bonded spunlaid nonwoven in accordance with this invention it is possible to overcome that deficiency, and to do so with little or no detriment to the strength of the final composite nonwoven. Furthermore, it is also possible to produce composite nonwoven fabrics that have improved bulk, hand and absorbency. The inventive composite nonwoven fabrics can also be dried satisfactorily without the formation of cockles.

Having generally described the invention, the following examples are included for purposes of illustration so that the invention may be more readily understood and are in no way intended to limit the scope of the invention unless otherwise specifically specified.

### EXAMPLE 1

A spunlaid base web having a nominal base weight of 30 gsm and comprising 100% PET 1-denier (0.111 tex) fibers was overlaid with a tissue in the form of a web comprising wood pulp fibers (Crofton ECH/Harmac K10S) containing approximately 38 gsm bone-dry fiber. The resultant multi-layer composite was then passed through a production-size hydroentanglement machine in which jets of water were directed at the tissue side of the said composite. Suction was applied from beneath the composite by means of vacuum boxes, in order to remove excess water.

Two different profiles of the water-jet apparatus were employed, which profiles are summarized in Table 1 hereinafter. In that Table, the column numbers 1 to 10 indicate the sequence of the nozzles. The figures in the “Bar” rows are the pressures employed, which are expressed in bar (1 bar=10⁵ Pa or approximately 14.5 lb-force/in²). The figures in the “Dia” rows are the nozzle diameters expressed in μm. The density of the 90 μm holes in the injectors was 2000 per meter (51 per inch) and the density of the 120 μm holes was 1666 per meter (45.2 per inch). The speed of the composite through the hydroentanglement machine was 46 meters per minute.

Furthermore, different grades of base web were used, the webs differing primarily in the temperature at which the thermal calendering operation was carried out. The base webs are identified as follows:

| | |
|---|---|
| Web 1: | Base web was bonded at 120° C. |
| Web 2: | Base web was bonded at 160° C. |
| Web 3: | Base web was bonded at 210° C. and represents a reference, |
| | normally bonded material. |

The composite nonwoven fabrics obtained by hydroentanglement were tested for various physical properties and the results obtained are shown hereinafter. The test methods were:

| | | |
|---|---|---|
| Basis Weight | TAPPI | T410 |
| Tensile Strength | TAPPI | T494* |
| Elongation | TAPPI | T494* |
| Elemendorf Tear | TAPPI | T414 |

*using a strain rate of 300 mm/min.

Table 2 shows the results for the said composite nonwoven fabrics under the heading “Base web+tissue”, the particular web being identified at the top of each column of results. The entanglement profile used is shown below. Tests were also carried out on samples of the starting spunbonded base webs without the addition of the tissue, and the results obtained are also shown in Table 2, under the heading “Base web”.

In addition, further trials were run in order to compare the results obtained for the starting base web, for the starting web after entanglement but without the tissue addition, and for the starting web subjected to entanglement with the tissue. The results from these trials are shown in Table 3 hereinafter. The results differ in certain respects from those recorded in Table 2. This is because the data was obtained from two different runs with slightly different machine settings; the natural variability of the materials also contributed to the differences.

TABLE 1

| Pro- | Injector Number | | | | | | | | | | |
|---|---|---|---|---|---|---|---|---|---|---|---|
| file | | 1 | 2 | 3 | 4 | 5 | 6 | 7 | 8 | 9 | 10 |
| 1 | Bar | 35 | 36 | 40 | 50 | 68 | 68 | 68 | 68 | 47 | 30 |
| | Dia | 90 | 90 | 90 | 90 | 90 | 90 | 90 | 90 | 90 | 90 |
| 2 | Bar | 6 | 30 | 50 | 60 | 70 | 80 | 85 | 85 | 85 | 80 |
| | Dia | 120 | 90 | 90 | 90 | 90 | 120 | 120 | 120 | 120 | 90 |

TABLE 2

| | Base Web + Tissue | | | | Base Web | | |
|---|---|---|---|---|---|---|---|
| | web 1 | web 2 | web 3 | web 2 | web 1 | web 2 | web 3 |
| Entanglement | 1 | 1 | 1 | 2 | none | none | none |
| Profile | | | | | | | |
| Basis Wt gsm | 76.1 | 75.3 | 73.1 | 73.9 | 30.7 | 32.3 | 25.2 |
| Dry Tensile, | 2918 | 2628 | 2231 | 3059 | 111 | 511 | 890 |
| MD N/m | | | | | | | |
| Dry Tensile, | 1393 | 1085 | 956 | 1409 | 38 | 148 | 444 |
| CD N/m | | | | | | | |
| Elmendorf | 11920 | 10520 | 5000 | 7080 | 10040 | 10240 | 4480 |
| Tear, MD mN | | | | | | | |
| Elmendorf | 13440 | 12480 | 6560 | 12160 | — | — | — |
| Tear, CD mN | | | | | | | |
| Dry | 42 | 34.6 | 23.4 | 42.9 | 5.7 | 7.6 | 18.5 |
| Elongation, | | | | | | | |
| MD (%) | | | | | | | |
| Dry | 99.4 | 86.4 | 45.6 | 92.6 | 40.3 | 22.3 | 20.5 |
| Elongation, | | | | | | | |
| CD (%) | | | | | | | |

TABLE 3

| | Web 1 | | | Web 2 | | | Web 3 | | |
|---|---|---|---|---|---|---|---|---|---|
| Entanglement | none | 1 | 1 | none | 1 | 1 | none | 1 | 1 |
| Profile | web | web | web + | web | web | web + | web | web | web + |
| | | | tissue | | | tissue | | | tissue |
| Basis Weight | 31 | 32 | 74 | 32 | 33 | 75 | 25 | 32 | 73 |
| gsm | | | | | | | | | |
| Tensile MD | 111 | 881 | 2548 | 511 | 204 | 2705 | 890 | 1138 | 2231 |
| N/m | | | | | | | | | |
| Tensile CD | 38 | 536 | 1429 | 148 | 272 | 1404 | 444 | 567 | 956 |
| N/m | | | | | | | | | |
| Elmendorf MD | 10040 | 15720 | 13560 | 10240 | 14440 | 13520 | 4480 | 6040 | 5000 |
| MN | | | | | | | | | |

### EXAMPLE 2

Three spunlaid base webs made from 100% polypropylene were used. Their basic characteristics were as follows:

TABLE 4

| | Web 4 | Web 5 | Web 6 |
|---|---|---|---|
| Nominal basis weight (gsm) | 28 | 28 | 28 |
| Fiber Diameter (Denier) | 1.0 | 1.5 | 2.2 |
| Bonding Temperature (° C.) | 90 | 90 | 137 |

Web 6 represents a reference, normally bonded material.

These webs were each subjected to three different processing combinations as follows:

(a) A sample of each web was subjected to hydro-entanglement on Laboratory equipment using Profile 2 in Table 1 of Example 1. The samples were then dried.

(b) A sample of each web was overlaid with a tissue containing wood pulp fibers (Harmac K10) containing the equivalent of approximately 58 gsm of bone-dry fiber. The composites were then subjected to hydro-entanglement again using Profile 2 in Table 1 of Example 1 on a laboratory unit. The entangled composites were then dried.

(c) Duplicate samples, made according to (b) above, were placed in concentrated sulfuric acid (95%) at room temperature in order to etch out the wood pulp fibers. The concentration and nature of the acid was chosen so that it would have no effect on the polypropylene fibers. The thus “regenerated” web was then washed in water and dried.

The samples from all three processing conditions were then tested for tensile strength; the results are shown in Table 5.

TABLE 5

| | | Tensile MD | Tensile CD |
|---|---|---|---|
| | | N/m | N/m |
| Web 4 | untreated base web | 184 | 51 |
| | entangled base web | 118 | 88 |
| | entangled base web + tissue | 1644 | 508 |
| | regenerated baseweb | 71 | 0 |
| | Contribution To Composite From | 11.2% | 10.0% |
| | Untreated Baseweb | | |
| Web 5 | untreated base web | 103 | 59 |
| | entangled base web | 83 | 118 |
| | entangled base web + tissue | 1691 | 900 |
| | regenerated baseweb | 0 | 0 |
| | Contribution To Composite From | 6.1% | 6.6% |
| | Untreated Baseweb | | |
| Web 6 | untreated base web | 1103 | 758 |
| | entangled base web | 995 | 688 |
| | entangled base web + tissue | 1824 | 998 |
| | regenerated baseweb | 862 | 629 |
| | Contribution To Composite From | 60.5% | 76.0% |
| | Untreated Baseweb | | |

### EXAMPLE 3

Three spunlaid basewebs made from 100% polypropylene were used. Their basic characteristics are listed in TABLE 6.

TABLE 6

| | Web 7 | Web 8 | Web 9 |
|---|---|---|---|
| Nominal basis weight (gsm) | 17 | 17 | 17 |
| Fiber Diameter (Denier) | 2.2 | 2.2 | 2.2 |
| Bonding Temperature (° C.) | 128 | 110 | 137 |

Web 9 represents a reference, normally bonded material.

These webs were subjected to three different processing combinations as follows:

(a) A sample of each web was subjected to hydro-entanglement on laboratory equipment using the profile given below in Table 7 and dried.

TABLE 7

| | Injector Number | | | | | | | | | | |
|---|---|---|---|---|---|---|---|---|---|---|---|
| Profile | | 1 | 2 | 3 | 4 | 5 | 6 | 7 | 8 | 9 | 10 |
| 3 | Bar | 15 | 30 | 40 | 50 | 60 | 60 | 60 | 60 | 60 | 60 |
| | Dia | 90 | 90 | 90 | 90 | 90 | 90 | 90 | 90 | 90 | 90 |

(b) A sample of each web was overlaid with a tissue containing wood pulp fibers (Harmac K10S) containing the equivalent of approximately 38 gsm of bone-dry fiber. The composites were than subjected to hydro-entanglement using the above Profile 3 on a laboratory unit. The entangled composites were then dried.

(c) Duplicate samples, made according to (b) above, were placed in concentrated sulfuric acid (95%) at room temperature in order to etch out the wood pulp fibers. The concentration and nature of the acid was chosen so that it would have no effect on the polypropylene fibers. The thus “regenerated” web was then washed in water and dried.

The samples from all three processing conditions were then tested for tensile strength, the results of which are shown in Table 8.

TABLE 8

| | | Tensile | Tensile |
|---|---|---|---|
| | | MD (N/m) | CD (N/m) |
| Web 7 | untreated base web | 273 | 227 |
| | entangled base web | 228 | 191 |
| | entangled base web + tissue | 941 | 504 |
| | regenerated baseweb | 324 | 106 |
| | Contribution To Composite From | 29.0% | 45.0% |
| | Untreated Baseweb | | |
| Web 8 | untreated base web | 306 | 174 |
| | entangled base web | 152 | 122 |
| | entangled base web + tissue | 1006 | 439 |
| | regenerated baseweb | 42 | 63 |
| | Contribution To Composite From | 30.4% | 39.6% |
| | Untreated Baseweb | | |
| Web 9 | untreated base web | 624 | 462 |
| | entangled base web | 556 | 383 |
| | entangled base web + tissue | 1026 | 643 |
| | regenerated baseweb | 780 | 478 |
| | Contribution To Composite From | 60.8% | 71.9% |
| | Untreated Baseweb | | |

### EXAMPLE 4

Two spunlaid base webs as in Example 1 and made from 100% polyester were used. Their basic characteristics are listed in TABLE 9.

TABLE 9

| | Web 2 | Web 3 |
|---|---|---|
| Nominal basis weight (gsm) | 30 | 30 |
| Fiber diameter (denier) | 1.0 | 1.0 |
| Bonding temperature (° C.) | 160° C. | 210° C. |

Web 3 represents a reference, normally bonded material.

These webs were subjected to three different processing combinations as follows:

(a) A sample of each web was subjected to hydro-entanglement on a laboratory unit using Profile 1 in Table 1 of Example 1. The samples were then dried.

(b) Each web was overlaid with a tissue containing wood pulp fibers (Harmac K10S) containing the equivalent of approximately 38 gsm of bone-dry fiber. The composites were then subjected to hydro-entanglement using the said Profile 1 on a laboratory unit. The entangled composites were then dried on steam-filled cans.

(c) Duplicate samples, made according to (b) above, were placed in concentrated sulfuric acid (75%) at room temperature in order to etch out the wood pulp fibers. The concentration and nature of the acid was chosen so that it would have no effect on the polyester fibers. The thus “regenerated” web was then washed in water and dried.

The samples from all three processing conditions were then tested for tensile strength, the results of which are show in Table 10.

TABLE 10

| | | Tensile | Tensile |
|---|---|---|---|
| | | MD (N/m) | CD (N/m) |
| Web 2 | untreated base web | 468 | 149 |
| | entangled base web | 204 | 272 |
| | entangled base web + tissue | 1944 | 773 |
| | regenerated baseweb | 247 | 75 |
| | Contribution To Composite From | 24.1% | 19.3% |
| | Untreated Baseweb | | |
| Web 3 | untreated base web | 890 | 444 |
| | entangled base web | 1138 | 567 |
| | entangled base web + tissue | 1853 | 921 |
| | regenerated baseweb | 956 | 448 |
| | Contribution To Composite From | 48.0% | 48.2% |
| | Untreated Baseweb | | |

### EXAMPLE 5

Previously described Web 2 was used for this example. Samples were prepared as follows:

(a) Layers of wood pulp of varying weights were combined with samples of web 2 by forming the wood pulp layers directly onto the baseweb using standard wetlaying handsheet mold apparatus. Woodpulp additions were from nominally 5 gsm to nominally 40 gsm of bone-dry fiber. The fiber used was Harmac K10S; it was dispersed in a standard laboratory pulper but was given no additional processing (such as refining or beating).

(b) Duplicate samples of each weight addition of (a) above were subjected to hydro-entanglement using Profile 1 in Table 1 of Example 1 on a laboratory unit. The entangled composites were then dried.

(c) Separate sheets of wood pulp only at the same nominal weights as

(a) above were made and dried.

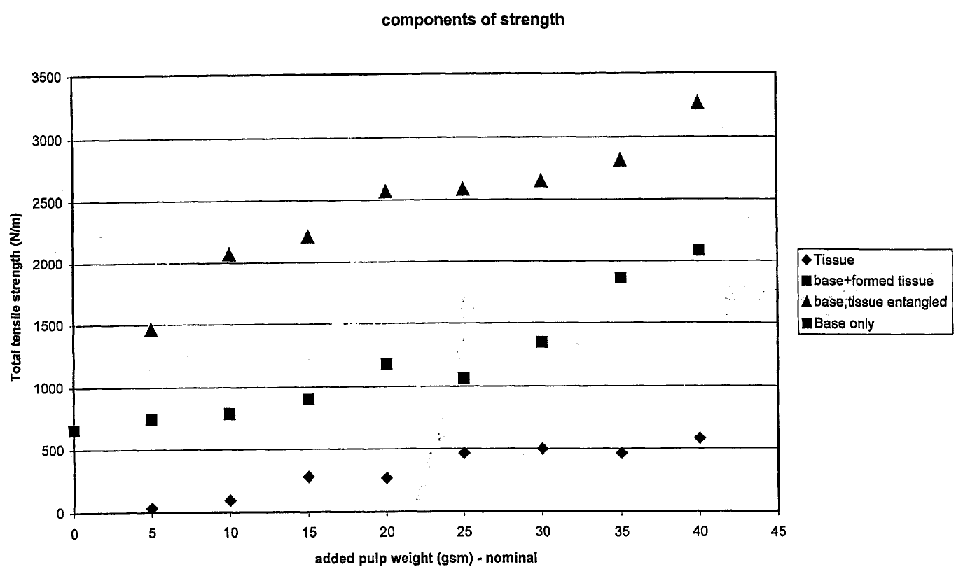

Four separate samples each of the woodpulp sheets, wood pulp/baseweb sheets and hydroentangled wood pulp/baseweb composite tested for basis weight and tensile strength. The average results for each are shown in Table 11 and graphically in FIG. 1.

As a result of hydro-entangling as little as 5 gsm of wood pulp into the baseweb, the strength of the baseweb is increased by a surprisingly large amount, i.e., the total tensile strength increases from 659 N/m in the baseweb alone to 1461 N/m after entanglement with 5 gsm of woodpulp (baseweb contributing only 45% of the final strength).

While preferred embodiments of the foregoing invention have been set forth for purposes of illustration, the foregoing description should not be deemed a limitation of the invention herein. Accordingly, various modifications, adaptations and alternatives may occur to one skilled in the art without departing from the spirit and scope of the present invention.

TABLE 11

| | | nominal weight of woodpulp addition (gsm) | | | | | | | | |
|---|---|---|---|---|---|---|---|---|---|---|
| sample | property | 0 | 5 | 10 | 15 | 20 | 25 | 30 | 35 | 40 |
| woodpulp | basis weight (gsm) | N/A | 5.5 | 8.7 | 15.5 | 49.6 | 24.0 | 29.3 | 34.0 | 38.6 |
| | total tensile strength (N/m) | N/A | 71 | 138 | 467 | 576 | 739 | 955 | 999 | 1179 |
| Web 2 + | basis weight (gsm) | 32.3 | 37.7 | 40.3 | 44.2 | 50.0 | 54.2 | 59.5 | 66.3 | 71.2 |
| woodpulp | total tensile strength (N/m) | 659 | 744 | 785 | 899 | 1177 | 1061 | 1345 | 1861 | 2086 |
| entangled Web 2 + | basis weight (gsm) | N/A | 36.6 | 40.4 | 45.8 | 50.5 | 54.7 | 58.9 | 65.0 | 71.4 |
| woodpulp | total tensile strength (N/m) | N/A | 1461 | 2069 | 2206 | 2566 | 2583 | 2647 | 2817 | 3263 |

What is claimed is:

1. A composite nonwoven fabric including:
a first nonwoven web comprised of a material selected from the group consisting of polymer filaments and polymer fibers, wherein the materials of the first web are less than fully bonded; and
a second nonwoven web comprised of cellulose pulp fibers joined to the first web by fiber entanglement.

2. The composite fabric of claim 1 wherein a strength of the first web is less than about 45% of a strength of the composite fabric.

3. The composite fabric of claim 1 wherein the first web comprises substantially continuous spunlaid filaments.

4. The composite fabric of claim 1 wherein the first web comprises substantially continuous spunlaid filaments of at least one thermoplastic polymer.

5. The composite fabric of claim 1 wherein the first web comprises substantially continuous spunlaid filaments of a material selected from the group consisting of polyethylene terephthalate, polypropylene and mixtures thereof.

6. The composite fabric of claim 1 wherein the first web comprises substantially continuous spunlaid filaments and wherein the first web is calendered at a temperature below a melting point of the filaments.

7. The composite fabric of claim 1 wherein the first web comprises substantially continuous spunlaid filaments and wherein the first web is calendered at a temperature below a softening point of the filaments.

8. The composite fabric of claim 1 wherein the first web is calendered at a temperature in the range of 120° C. to 180° C.

9. The composite fabric of claim 1 wherein the first web is calendered at a temperature in the range of 140° C. to 160° C.

10. The composite fabric of claim 1 wherein each of the first web and the second web are preformed.

11. The composite fabric of claim 1 wherein the first web consists essentially of substantially continuous thermoplastic filaments having a denier in the range of 0.5 to 2.5.

12. A process for producing a composite nonwoven fabric comprising:
forming a first nonwoven web comprised of a material selected from the group consisting of polymer filaments and polymer fibers;
minimally bonding the materials of the first web;
placing a second nonwoven web comprised of cellulose pulp fibers adjacent to the first web; and
joining the second web to the first web by fiber entanglement.

13. The process of claim 12 wherein a strength of the first web after minimal bonding is less than about 45% of a strength of the composite fabric.

14. The process of claim 12 comprising the step of wet laying cellulose pulp fibers to form the second web.

15. The process of claim 12 comprising the step of wet laying the cellulose pulp fibers to form the second web prior to the step of placing the second web adjacent to the first web.

16. The process of claim 12 wherein the step of joining comprises hydroentanglement of the fibers of the second web into the first web at a total entanglement energy input in the range of 0.07 to 0.4 horsepower-hours per pound.

17. The process of claim 12 wherein the step of forming comprises the step of extruding a polymer material into substantially continuous filaments and onto a forming surface, the polymer material selected from the group consisting of polyester, polyolefin and mixtures thereof; and the step of bonding consists essentially of heating the filaments to a temperature below a melting point of the polymer material.

18. The process of claim 12 wherein the step of forming comprises the step of extruding a polymer material into substantially continuous filaments; and the step of bonding consists essentially of thermal calendering of the filaments at a temperature below a filament softening point.

19. A composite fabric consisting essentially of:
spunlaid filaments comprised of a polymer material selected from the group consisting of polyester, polyolefin and mixtures thereof, the filaments being minimally bonded to form a first nonwoven web; and
a second web comprised of cellulose fibers entangled to the first web, wherein the first web has a tensile strength that is less than about 45% of a tensile strength of the composite fabric.

20. The composite fabric of claim 19 wherein the second web consists essentially of a preformed web.
